(19) United States
(12) Patent Application Publication
(10) Pub. No.: US 2026/0330522 A1
(43) Pub. Date: Oct. 22, 2026

(54) SYSTEMS AND METHODS FOR FACILITATING SECURE TRANSACTIONS AND QUALITY CERTIFICATION IN SPECIALTY COFFEE TRADING

(71) Applicant: Paulo Peres, Randolph, NJ (US)

(72) Inventor: Paulo Peres, Randolph, NJ (US)

(21) Appl. No.: 19/185,627

(22) Filed: Apr. 22, 2025

(51) Int. Cl. G06Q 30/0601

(52) U.S. Cl. CPC G06Q 30/0619; G06Q 30/0611; G06Q 30/0641

(57) ABSTRACT

The present disclosure relates to systems and methods for facilitating secure transactions and quality certification in specialty coffee trading. The described approach addresses inefficiencies in the current green coffee trade, characterized by lack of a centralized marketplace, fragmented systems and opaque price discovery. The solution involves an online marketplace and bilateral spot trading platform that receives coffee listing data, including parameters and quality grades from third-party certifications. A computing device generates coffee identifiers and displays listings with indicative offer prices, allowing buyers to submit counter-offers.

### FIELD

The present disclosure pertains to online trading platforms, specifically to systems and methods for facilitating secure transactions and quality certification in the trading of specialty coffee.

### BACKGROUND

The current green coffee trade is characterized by a complex and often fragmented system involving multiple stakeholders, including farmers, exporters, importers, roasters, and quality assessors. Traditionally, the trade is negotiated bilaterally, not in a central marketplace, and relies on manual processes and semi-digital systems, which can lead to significant inefficiencies and delays. Price discovery is often opaque, with limited access to real-time market data, resulting in information asymmetry and potential unfairness in transactions.

Quality verification is another critical aspect of the green coffee trade, where subjective assessments are conducted by trained professionals using established protocols, such as those from the Specialty Coffee Association (SCA). However, the integration of these quality assessments with market pricing is difficult, leading to inconsistencies and challenges in ensuring product credibility. The trade is further complicated by counterparty risks, as transactions typically require upfront payments, exposing buyers to potential delivery and quality issues. All parties in the current transactions are vulnerable to financial risks.

Because of these and other shortcomings, there is a strong need for systems and methods that provide improved methodologies for facilitating these market transactions.

### SUMMARY

In one embodiment, the disclosure provides a method for delivering an online marketplace and bilateral spot trading platform for green specialty coffee. The method comprises receiving coffee listing data from authorized users, wherein each listing includes a set of coffee parameters and at least one quality grade issued by a third-party quality certification. A computing device then determines a coffee group identifier for each listing based at least in part on the received parameters and generates an individual coffee identifier using the determined group identifier and quality grade information. A coffee group spreads curve is computed for each identifier based on historical trading data and current market information derived from a contemporaneous C-coffee traded financial instrument. The computed spreads curve, which represents indicative spot prices as a spread over the C-coffee price, is displayed on an online marketplace interface along with the associated coffee listings to provide an indicative offer price to sellers and an opportunity for buyers to submit counter-offer pricing data. Matching pairs of buy and sell orders are identified based on price and quantity criteria, and matching transactions are automatically executed by generating and transmitting electronic trade notifications along with a bilateral electronic trading agreement. The marketplace display is then updated to reflect executed transactions with details such as transacted quantities, volume-weighted prices, and last executed prices, and transaction data—including the listing data, generated identifiers, computed spreads curves, and transaction details—is stored.

In additional embodiments, the method further specifies that the coffee parameters may include origin, processing type, bean size, and production year, and that the quality grade may be an internationally recognized certification. Activation of a coffee listing can be contingent upon receipt of a coffee quality report from an accredited third-party quality assessment provider. The computation of the coffee group spreads curve may involve employing cubic spline functions and regression curve fitting techniques based on historical trading data and the current market price. The online marketplace interface may present the listings on a graphical user interface that enables buyers to view real-time volume-weighted prices, last executed prices for a predetermined minimum lot, and to submit counter-offer pricing data. Matching transactions may be executed through a dynamic double auction process in which pre-agreement bids and offers are maintained on a blind basis, and trade cancellations may be permitted within a predetermined period following trade notification subject to mutual agreement. Moreover, electronic trade notifications may include a legally binding spot trading agreement executed via an electronic signature process, while transaction data storage may incorporate timestamp information to facilitate audit and traceability. An escrow account service may also be provided, where a third-party financial institution holds the buyer's deposit until confirmation of delivery and quality assessment is received, thereby mitigating credit and performance risks.

In another embodiment, the disclosure provides a computer-implemented method for facilitating secure bilateral spot trading of green specialty coffee. Here, a computing device receives coffee listing data—including a set of parameters such as origin, processing type, bean size, and production year, along with a quality certification from an accredited third-party service —and generates distinct group and individual coffee identifiers based on the received information. A pricing curve is computed for each coffee group using both historical trading data and current market information from a contemporaneous C-coffee traded financial instrument. The coffee listings, together with their computed pricing curves, are displayed on an online marketplace interface, enabling sellers to access indicative offer prices and buyers to submit bid or counter-offer pricing data via a graphical user interface. The method continues with the receiving of pricing data, identifying matching pairs of buy and sell orders based on the submitted pricing and quantity criteria, and then automatically executing the matching orders to form a bilateral electronic trading agreement. Electronic trade notifications are generated and transmitted through an electronic signature process, and a deposit payment is routed to an escrow account service provider, which holds the funds until confirmation of both delivery and an independent quality assessment is received.

In yet another embodiment, the disclosure provides a system for facilitating secure bilateral spot trading of green specialty coffee via an online marketplace. The system comprises a network interface module configured to receive coffee listing data from authorized users, where each listing includes a set of coffee parameters and an associated quality certification from a third-party quality assessment service. A coffee identifier module determines a coffee group identifier for each listing and generates an individual coffee identifier based on the received data. A pricing module computes a coffee group spreads curve for each identifier using historical trading data and current market information from a contemporaneous C-coffee traded financial instrument. A display module presents the coffee listings along with their computed spreads curves on an online marketplace interface, thereby providing indicative offer prices and enabling buyers to submit counter-offer pricing data. A matching module identifies corresponding pairs of buy and sell orders based on price and quantity criteria and automatically transmits electronic trade notifications together with bilateral electronic trading agreements. An escrow module routes a deposit payment from a buyer to an escrow account service provider, which holds the payment until delivery confirmation and quality assessment are received, while a storage module stores transaction data including the original listing data, generated identifiers, computed spreads curves, and details of executed transactions.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1A is a flow chart diagram illustrating the process of facilitating secure transactions and quality certification in the trading of specialty coffee.

FIG. 1B is a flow chart diagram that continues from FIG. 1B.

FIG. 2A is a flow chart diagram illustrating the process of facilitating secure transactions and quality certification in the trading of specialty coffee.

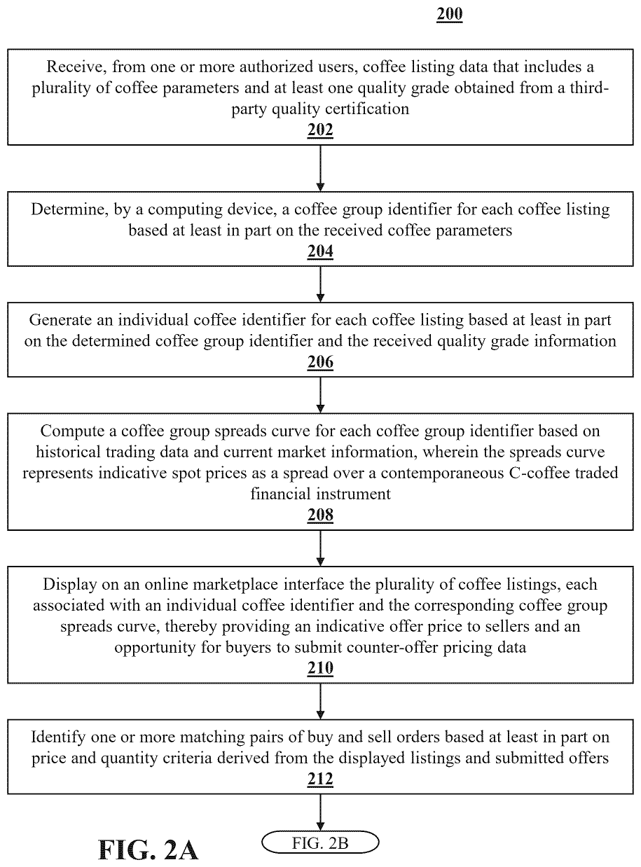

FIG. 2B is a flow chart diagram that continues from FIG. 2B.

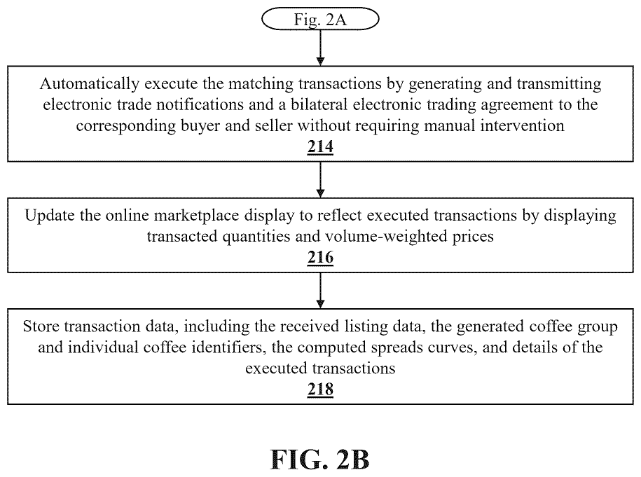

FIG. 3 is a schematic diagram of a transaction platform for use with the methods and systems disclosed herein.

### DETAILED DESCRIPTION

### Explanation of Terms

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” do not exclude the presence of intermediate elements between the coupled or associated items absent specific contrary language.

As used herein, a “C-coffee traded financial instrument” refers to a standardized futures contract for commodity coffee, of the type typically traded on major commodity exchanges.

As used herein, the term “spot trading” refers to purchase and sale of a commodity, like coffee, that involves transactions where the buyer and seller agree on a price, and the physical delivery of the commodity occurs shortly thereafter. Although the delivery of coffee may occur within a few days of the transaction agreement, the term spot trading, as used herein, is not limited to any particular delivery window. The price agreed upon in a spot trade reflects the current market value, or “spot price,” of the commodity at the time of the transaction.

As used herein, the term “coffee group spreads” refers to price differentials or spreads calculated for a group of coffee products that share similar attributes, such as origin, processing type, and quality grade. These spreads can be computed, for example, based on historical trading data and current market information. In some examples, the coffee group spreads can represent indicative spot prices as a spread over a contemporaneous C-coffee traded financial instrument, providing a benchmark for pricing within the coffee group.

As used herein, the term “escrow” refers to a financial arrangement in which a third-party service provider holds and manages funds on behalf of the transacting parties involved in a transaction, such as the specialty coffee trades described herein.

As used herein, the term “specialty coffee” refers to coffee that is recognized for its distinctive attributes, resulting in a higher value within the marketplace. Specialty coffee is typically characterized by superior quality, unique flavor profiles, and specific production methods that differentiate it from commodity coffee.

As used herein, the term “dynamic double-action trading” refers to a trading mechanism where buyers and sellers place competitive blind bids and offers. In dynamic double-action trading, as used herein, pre-agreement bids and offers are maintained on a blind basis, meaning that the identities of the parties and the specifics of their bids or offers are not disclosed until a match is found.

As used herein, the term “indicative offer price” refers to a preliminary price suggested by the systems and methods disclosed herein for a coffee listing, based on a calculation that considers historical and current market conditions. This price serves as a benchmark for sellers, providing them with an initial valuation of their coffee product.

Although there are alternatives for various components, dimensions, parameters, operating conditions, etc., set forth herein, that does not mean that those alternatives are necessarily equivalent and/or perform equally well. Nor does it mean that the alternatives are listed in a preferred order unless stated otherwise.

### Overview of the Disclosed Technology

The systems and methods described herein provide a novel marketplace and trading platform specifically designed for the bilateral spot trading of green specialty coffee. This platform aims to address the current shortcomings by providing a transparent and efficient trading environment. The platform facilitates direct and anonymous transactions between buyers and sellers, ensuring efficient price discovery and reducing credit risk for buyers through the use of an escrow account service. Additionally, the platform adopts one or more universal product classification system, allowing for precise comparisons across coffee varieties and accurate mapping to pricing curves. This system ensures fair and consistent valuation of all products offered on the platform, promoting transparency and fairness in the specialty coffee market.

### Embodiments of the Disclosed Technology

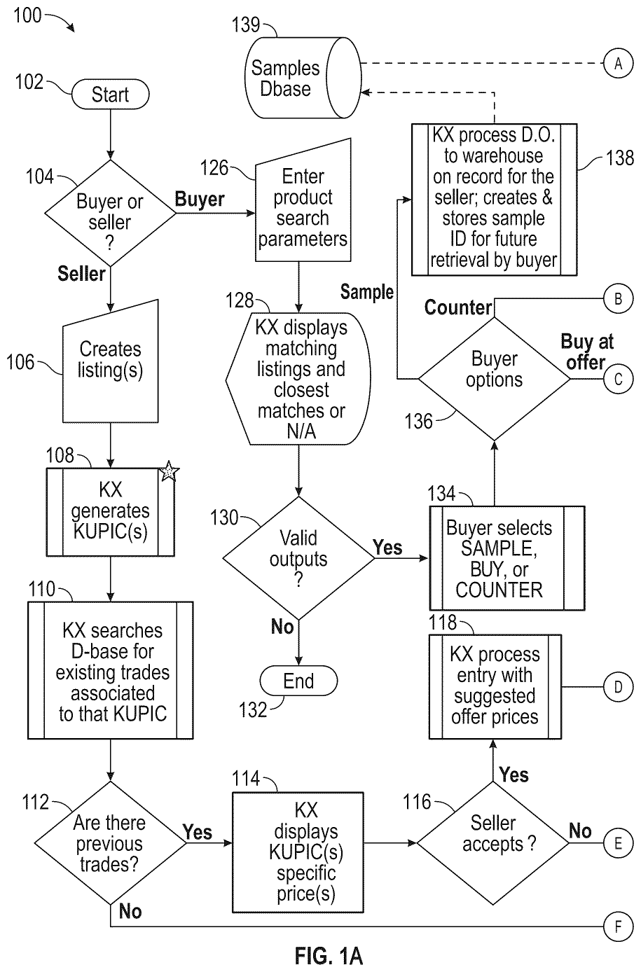

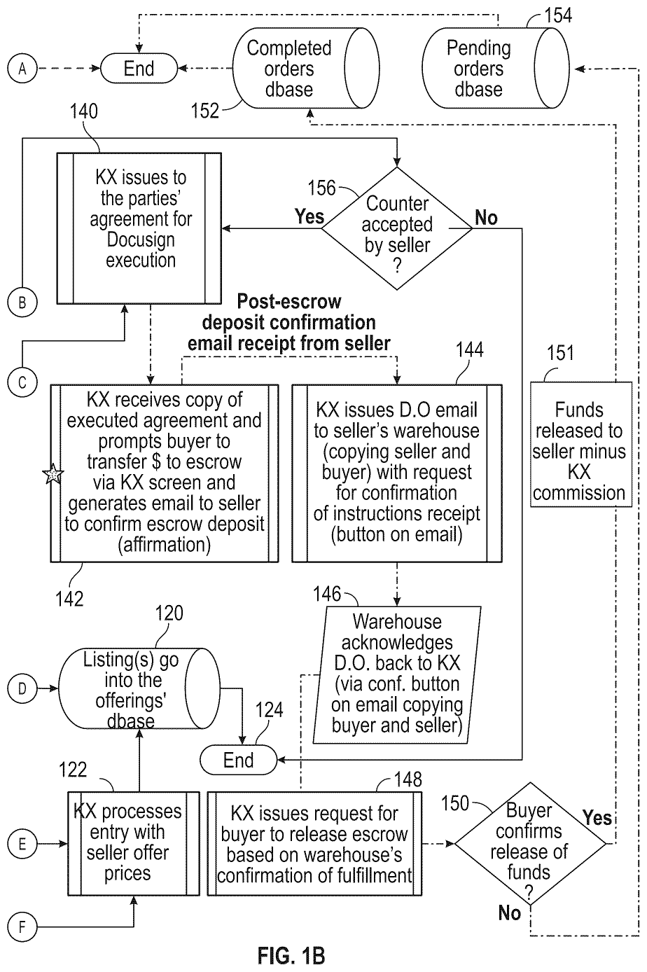

FIGS. 1A and 1B are flow chart diagrams illustrating the process of facilitating secure transactions and quality certification in the trading of specialty coffee.

The process 100 begins at step 102, which initiates the operation of the trading platform. This next step 104 serves as the entry point for users, prompting them to identify their role as either a buyer or a seller. The decision made at this stage determines the subsequent path within the trading process, directing users to either create listings or enter search parameters.

Sellers proceed to list their coffee products, while buyers are directed to search for available listings. For sellers, at step 106 (“Creates listing(s)”) the sellers are able to input details about their coffee products into the platform. In this manner, the system can gather important information such as coffee parameters, quality grades, and other relevant data that will be used to generate an identifier for each listing. This step provides the necessary data for the platform to generate a code, e.g., a Kaffea-X Universal Product Identification Code (KUPIC) at step 108, to facilitate subsequent trading activities. As used herein, the term Kaffea-X is occasionally used to refer to particular branding associated with the platform. It should be understood that the term platform and the term Kaffea-X platform, or similar combinations, can be interchangeably used.

The KUPIC is a unique alphanumeric identifier generated by the platform for each coffee listing. This code is based on the coffee's attributes, including, for example, its origin, processing type, bean size, and production year, as well as a quality grade, as provided by an accredited third-party quality assessment service. The KUPIC serves as a distinctive identifier that allows for precise comparisons across coffee varieties, facilitating trading. By standardizing product identification, KUPIC ensures transparency and consistency in the valuation of coffee products on the platform, promoting fair and efficient trading in the specialty coffee market.

At step 110 (“KX searches D-base for existing trades associated to that KUPIC”) the system queries the platform's database to identify any previous trades (e.g., step 112) associated with the generated KUPIC. This step provides sellers with historical pricing data and trade information, which can inform their pricing strategies and offer decisions. By accessing existing trade data, sellers can make informed decisions about their listings. If previous trades are found, the process continues to display specific prices (e.g., suggested pricing) related to those trades at step 114.

At step 116, the seller can accept the suggested pricing or reject the suggested pricing. If the buyer accepts the suggested pricing at step 118, the system proceeds to list the KUPIC with the suggested pricing, and at step 120 the listings go into the database for offerings.

If the seller rejects the suggested pricing, the seller can select and enter their own suggested pricing at step 122, and the seller created pricing enters into the database for offerings (e.g., step 120). This completes the listing process (step 124).

In the case of buyers, at step 126, the buyers can enter product search parameters to input criteria for the coffee listings they wish to find. This allows the buyers to filter the available listings based on the buyer's preferences, such as origin, processing type, and quality grade. By entering search parameters, buyers can efficiently locate coffee products that match their requirements, streamlining the process of finding suitable listings on the platform.

At step 128, the system displays matching listings and/or the closest matches, if any. The matching listings inform the buyers of their options moving forward, and facilitates the selection process by displaying the relevant information about each listing.

At step 130, the process either ends (i.e., at step 132 if there are no valid outputs) or continues at steps 134 and 136 where the buyer can review the matching listings and decide to buy at the listed price or counteroffer.

In some embodiments, the buyer can optionally also request a sample. At step 138, the sample request can be processed, e.g. prepared and sent to a location, such as a warehouse on record for the seller, where a sample can be created & stored with a unique sample ID for future retrieval by buyer.

Preferably, anonymity between the sample requester and provider can be maintained. For example, when a buyer requests a sample of a coffee listing, the system generates a sample ID that is associated with the specific coffee product but does not reveal the identities of the buyer or seller. This sample ID is used to track the sample throughout the logistics process, ensuring that the sample can be prepared, stored, and retrieved without disclosing personal or business information of the involved parties.

The sample ID acts as a reference point for both the buyer and seller, allowing them to manage the sample request and delivery without direct interaction. The platform handles all communications and logistics using this identifier, thereby preserving the anonymity of the participants. The sample ID is linked to the coffee's attributes and quality grade, enabling the buyer to assess the sample's credibility and make informed purchasing decisions while maintaining privacy. This approach mitigates potential biases or influences that could arise from knowing the identities of the parties involved, promoting fairer and unbiased transactions. In some embodiments, available samples can be stored in a samples database at step 139. Thus, a potential buyer will know in advance whether a sample is available or not.

Returning again to step 136, the buyer can agree to purchase at the listed price or counteroffer. If the buyer agrees to the purchase at the listed price, the system issues agreement documents to the parties at step 140, such as by an online authentication and signing system like DocuSign®. In this manner, the system generates and transmits suitable electronic trade agreements to the corresponding buyer and seller for execution via DocuSign. This formalizes the transaction and ensures that both parties have a legally binding agreement.

The platform can be configured to accommodate the diverse legal and logistical requirements of international coffee trading by preparing different agreements based on the geographical location of the trading parties. This ensures compliance with regional standards and practices, facilitating smooth transactions across borders. For example, for transactions involving parties located in the United States or regions where the Green Coffee Association's standards are recognized, the platform may prepare agreements based on these terms. These contracts typically include specifications related to quality, delivery, and payment, adhering to the established norms of the U.S. coffee trade.

In another example, for transactions involving parties located in Europe or regions where the European Coffee Federation's standards are applicable, the platform may prepare agreements based on these terms. These contracts are tailored to meet the specific requirements of the European coffee market, including quality assurance, logistics, and financial arrangements.

In yet another example, for parties located outside of the US or Europe, or for parties that prefer another agreement to meet particular trading practices or legal requirements, the platform may prepare custom agreements that incorporate different standards and regulations.

By preparing agreements that align with the geographical location of the trading parties, the platform ensures that transactions are conducted in accordance with relevant legal frameworks and industry standards. This approach minimizes the risk of disputes and enhances the reliability and efficiency of international coffee trading, providing a seamless experience for buyers and sellers across different regions.

Upon execution, at step 142, the platform can provide copies to buyer and seller of the executed agreement, and prompt the buyer to transfer the appropriate funds to escrow. Upon escrow deposit, the platform generates email to seller to confirm escrow deposit (affirmation).

At step 144, the platform issues instructions (e.g., by email) to seller's warehouse (e.g., copying seller and buyer in the form of a delivery order (D.O)) with a request for confirmation of instructions receipt. This ensures that both parties are informed of the delivery instructions and confirms the warehouse's acknowledgment at step 146. Thus, upon receipt of the instructions, the warehouse is informed, acknowledges the delivery order, and confirms that the fulfillment of the order is being processed.

At step 148, the platform requests that the buyer release escrow based on buyer's confirmation of fulfillment. At step 150, the warehouse either confirms that the funds are released from escrow and the order is completed (step 152), or does not confirm the transfer and the order is held as a pending order (step 154). If the escrow funds are released, at step 151, the funds are released to the seller minus a commission charged by the platform.

Returning again to step 136, the buyer can counteroffer. If the buyer counteroffers, at step 156, the counteroffer can be accepted or rejected by the seller. If accepted, the process proceeds to step 140 (discussed above) for formalization of the agreement. If rejected, the process ends (step 124).

The component at step 122 handles the entry of seller offer prices into the platform. This component is responsible for processing the seller's pricing data and updating the marketplace display, accordingly, ensuring that buyers have access to accurate and transparent pricing information.

### Further Details of the Disclosed Technology

As described above, the Universal Product Identification Code (KUPIC) for coffee represents a significant innovation in the specialty coffee trading industry. This feature introduces a standardized code that encapsulates the unique attributes of each coffee product, including its origin, processing type, bean size, production year, and quality grade. By integrating these diverse parameters into a single identifier, KUPIC transforms the way coffee is classified and traded, offering a level of precision and transparency previously unattainable in the market. This improvement not only facilitates transparent pricing but also enhances traceability, allowing buyers and sellers to track the provenance and quality of coffee throughout the supply chain.

The implementation of KUPIC is particularly significant in promoting fairness and efficiency in the specialty coffee market. By ensuring that each coffee product is evaluated against a uniform set of attributes, KUPIC eliminates the biases and discrepancies that can arise from subjective assessments. This standardization fosters a more equitable trading environment, where coffee products are valued based on their intrinsic qualities rather than external influences.

Moreover, KUPIC's ability to map coffee products to pricing curves introduces a new dimension of market analysis, providing traders with insights into price trends and market dynamics. This feature empowers stakeholders to engage in more strategic trading practices, optimizing their pricing strategies and enhancing their competitive edge in the market.

The platform also leverages third-party certification quality assessment services to ensure the quality and authenticity of coffee products. These services are provided by accredited entities that specialize in evaluating coffee based on established standards and protocols, such as those from the Specialty Coffee Association (SCA).

The process begins with sellers submitting their coffee products to the third-party certification service for evaluation. These services conduct thorough assessments, examining various attributes of the coffee, including flavor, aroma, acidity, and body. The evaluation is performed using standardized protocols, ensuring that the assessment is objective and consistent across different coffee varieties. Upon completion, the service issues a quality grade certification that reflects the coffee's attributes and overall quality.

This certification becomes a permanent part of the coffee's listing on the platform, including by its incorporation into the KUPIC, providing buyers with verified quality information. This integration of third-party certification into the trading process enhances the credibility and reliability of the marketplace.

The benefits of utilizing third-party certification quality assessment services are manifold. For buyers, the certification acts as a guarantee of quality, reducing the risk of purchasing substandard or misrepresented coffee products. For sellers, third-party certification offers a recognized standard of quality that can differentiate their products in the market. Certified coffee listings are more likely to attract buyers who prioritize quality and traceability, enhancing the marketability of the seller's offerings. Additionally, the certification provides a consistent framework for evaluating coffee quality, eliminating biases and subjective assessments, and promoting transparency in the trading process.

The automated electronic trading platform for specialty coffee described herein presents a significant leap forward in the modernization of coffee trading practices. This includes a sophisticated digital marketplace designed to streamline the trading process, enhance transparency, and mitigate risks associated with traditional coffee transactions. By leveraging advanced technology, the platform offers a seamless and efficient trading environment that caters to the unique needs of the specialty coffee industry.

In the traditional coffee market, transactions are often hindered by lack of a centralized marketplace, manual processes, fragmented systems, and a lack of real-time data, leading to inefficiencies and delays. The automated electronic trading platform addresses these challenges by providing a centralized digital space where buyers and sellers can interact directly and anonymously. This innovation facilitates efficient price discovery, allowing participants to access real-time market data and make informed decisions based on current trends and pricing dynamics.

The platform also incorporates a dynamic double-action trading mechanism, where competitive blind bids and offers are placed by participants. Trades are executed at the intersection of the highest bid and lowest offer, enabling flexible price discovery and promoting market transparency. This mechanism allows sellers to accept lower suggested prices, fostering a more adaptable and responsive trading environment.

Additionally, the platform described provides for sophisticated methods for calculating and representing spot prices for coffee holdings of varying quality grades within a specific coffee group. By employing specific algorithms, such as cubic spline functions and regression curve fitting techniques, coffee group identifier spreads curves can be developed and presented to provide traders with a precise and dynamic tool for price discovery. Presenting indicative spot prices as a spread over a contemporaneous C-coffee traded financial instrument ensures that the pricing reflects the latest market conditions and trends.

### Exemplary Transaction Platform

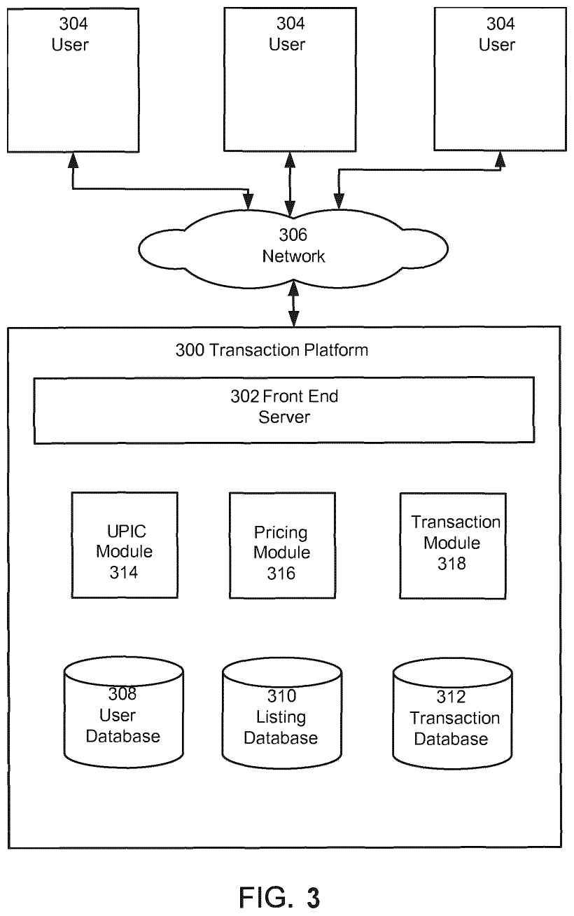

FIG. 3 shows a transaction platform 300 designed to facilitate secure bilateral spot trading of green specialty coffee, as described herein. The transaction platform 300 is connected to multiple users 304 (e.g., buyers and sellers) via a network 306. Within the transaction platform 300, there can be a front end server 302, a UPIC module 314, a pricing module 316, a transaction module 318, a user database 308, a listing database 310, and a transaction database 312.

The user 304 interacts with the transaction platform 300 through the network 306. This interaction allows the user 304 to access the platform's functionalities, including listing coffee products, submitting offers, and executing trades. The network 306 serves as the communication medium, ensuring seamless data exchange between the user 304 and the transaction platform 300.

The front end server 302 handles user interactions and requests. This server offers the interface that allows user 304 to access the platform's services. The front end server 302 processes incoming data from the network 306 and collaborates with other modules within the transaction platform 300 to provide the necessary functionalities.

The UPIC Module 314 generates identifiers for coffee listings, as described herein, based on their attributes, such as origin, processing type, and quality grade. This module ensures that each coffee product is distinctly identified, facilitating precise comparisons and efficient trading on the platform.

The pricing module 316 computes suggested pricing for different products with unique identifiers, such as pricing curves for coffee listings using historical trading data and current market information. This module provides indicative spot prices, enabling users 304 to make informed pricing decisions. The calculations performed by the module are important for establishing fair market values for coffee products.

The transaction module 318 manages the execution of trades between buyers and sellers. The module identifies matching pairs of buy and sell orders based on price and quantity criteria and automatically generates electronic trade notifications and agreements.

The user database 308 stores information related to the users 304, including their profiles and transaction history. The listing database 310 contains data on coffee listings, including their attributes and pricing information. This database supports the platform's capability to present accurate and current listings to users 304. The transaction database 312 records details of executed transactions, including timestamps and pricing data.

### Additional Examples

The following clauses provide additional examples of the disclosure provided herein.

1: A method for providing an online marketplace and bilateral spot trading platform for green specialty coffee, may include: receiving, from one or more authorized users, coffee listing data that includes a plurality of coffee parameters and at least one quality grade obtained from a third-party quality certification; determining, by a computing device, a coffee group identifier for each coffee listing based at least in part on the received coffee parameters; generating an individual coffee identifier for each coffee listing based at least in part on the determined coffee group identifier and the received quality grade information; computing a coffee group spreads curve for each coffee group identifier based on historical trading data and current market information, where the spreads curve represents indicative spot prices as a spread over a contemporaneous C-coffee traded financial instrument; displaying on an online marketplace interface the plurality of coffee listings, each associated with an individual coffee identifier and the corresponding coffee group spreads curve, thereby providing an indicative offer price to sellers and an opportunity for buyers to submit counter-offer pricing data; identifying one or more matching pairs of buy and sell orders based at least in part on price and quantity criteria derived from the displayed listings and submitted offers; automatically executing the matching transactions by generating and transmitting electronic trade notifications and a bilateral electronic trading agreement to the corresponding buyer and seller without requiring manual intervention; updating the online marketplace display to reflect executed transactions by displaying transacted quantities and volume-weighted prices; and storing transaction data, including the received listing data, the generated coffee group and individual coffee identifiers, the computed spreads curves, and details of the executed transactions.

2: The method as paragraph 1 describes, where the plurality of coffee parameters includes origin, processing type, bean size, and production year.

3: The method as either of paragraphs 1 or 2 describe, where the at least one quality grade is an internationally recognized quality certification.

4: The method as any of paragraphs 1-3 describe, further may include receiving a coffee quality report generated by an accredited third-party quality assessment service provider, where activation of a coffee listing is contingent upon receipt of the coffee quality report.

5: The method as any of paragraphs 1-4 describe, where computing the coffee group spreads curve may include employing cubic spline functions and regression curve fitting techniques based on the historical trading data and the current price of a contemporaneous C-coffee traded financial instrument.

6: The method as any of paragraphs 1-5 describe, where displaying the online marketplace interface may include presenting the coffee listings on a graphical user interface that enables buyers to submit counter-offer pricing data and view real-time volume-weighted prices and last executed prices for a predetermined minimum lot.

7: The method as any of paragraphs 1-6 describe, further may include automatically executing the matching transactions through a dynamic double auction process, where pre-agreement bids and offers are listed anonymously.

8: The method as any of paragraphs 1-7 describe, where trade cancellations are permitted within a predetermined period following trade notification, subject to mutual agreement of the buyer and seller.

9: The method as any of paragraphs 1-8 describe, further may include generating and transmitting electronic trade notifications that include a legally binding spot trading agreement executed via an electronic signature process.

10: The method as any of paragraphs 1-9 describe, where updating the online marketplace display further may include reflecting transacted quantities, volume-weighted prices, and the last executed price per pound for a minimum lot of coffee.

11: The method as any of paragraphs 1-10 describe, where storing the transaction data may include recording timestamps for each receipt of coffee listing data, execution of transactions, and marketplace display update to facilitate audit and traceability.

12: The method as any of paragraphs 1-11 describe, where the escrow account service provider is a third-party financial institution that holds the buyer's deposit payment until confirmation of delivery and quality assessment of the coffee, at which point the funds are released to the seller, thereby mitigating credit and performance risk associated with the trade.

13: A computer-implemented method for facilitating secure bilateral spot trading of green specialty coffee, the method may include: receiving, via a computing device, coffee listing data from one or more authorized users, the coffee listing data including a set of coffee parameters may include origin, processing type, bean size, and production year, and a quality grade certification provided by an accredited third-party quality assessment service provider; generating, by the computing device, a distinct coffee group identifier for each coffee listing based at least in part on the received set of coffee parameters; generating, by the computing device, an individual coffee identifier for each coffee listing based at least in part on the generated coffee group identifier and the quality grade certification; computing, by the computing device, a pricing curve for each coffee group identifier based on a combination of historical spot trading data for green specialty coffee and a current market price derived from a contemporaneous C-coffee traded financial instrument, where the pricing curve represents indicative spot price spreads for varying quality grades within the coffee group; displaying, on an online marketplace interface accessible to the authorized users, the plurality of coffee listings, each associated with the distinct individual coffee identifier and the corresponding pricing curve, thereby providing an indicative offer price to sellers and enabling buyers to submit counter-offer pricing data; receiving, via the computing device, bid or counter-offer pricing data from a buyer for a selected coffee listing; identifying, by the computing device, at least one matching pair of buy and sell orders based at least in part on bid and offer prices and quantity criteria derived from the displayed listings and submitted pricing data; automatically executing, by the computing device, the matching pair of buy and sell orders to form a bilateral electronic trading agreement and generating electronic trade notifications for the corresponding buyer and seller without requiring manual intervention; and routing a deposit payment from the buyer to an escrow account service provider, where the escrow account service provider holds the payment until confirmation of delivery and quality assessment of the coffee is received, at which point the funds are released to the seller.

14: The computer-implemented method as paragraph 13 describes, where displaying the online marketplace interface further may include presenting real-time volume-weighted prices and the last executed price per pound for a predetermined minimum lot of coffee.

15: The computer-implemented method as either of paragraphs 13 or 14 describe, further may include identifying the matching pair of buy and sell orders by implementing a dynamic double auction process where pre-agreement bids and offers are maintained on a blind basis.

16: The computer-implemented method as any of paragraphs 13-15 describe, where receiving the bid or counter-offer pricing data may include accepting such pricing data via a graphical user interface that presents the coffee listings and corresponding pricing curves in real time.

17: The computer-implemented method as any of paragraphs 13-16 describe, where automatically executing the matching pair of buy and sell orders further may include generating and transmitting electronic trade notifications that include a legally binding spot trading agreement executed via an electronic signature process.

18: The computer-implemented method as any of paragraphs 13-17 describe, where routing the deposit payment further may include transmitting an electronic confirmation notification to the corresponding buyer and seller upon receipt of the deposit payment by the escrow account service provider.

19: The computer-implemented method as any of paragraphs 13-18 describe, where the escrow account service provider is a third-party financial institution that holds the buyer's deposit payment until confirmation of both physical delivery and an independent quality assessment of the coffee is received, and where the funds are released to the seller thereafter.

20: A system for facilitating secure bilateral spot trading of green specialty coffee via an online marketplace, may include: a network interface module configured to receive, from one or more authorized users, coffee listing data that includes a set of coffee parameters and an associated quality certification from a third-party quality assessment service provider; a coffee identifier module configured to determine a coffee group identifier for each coffee listing based at least in part on the received coffee parameters and to generate an individual coffee identifier for each listing based at least in part on the determined coffee group identifier and the associated quality certification; a pricing module configured to compute a coffee group spreads curve for each coffee group identifier based at least in part on historical trading data and current market information derived from a contemporaneous C-coffee traded financial instrument, where the computed spreads curve represents indicative spot prices as a spread over the C-coffee price; a display module operatively coupled to the network interface module and configured to present on an online marketplace interface the plurality of coffee listings, each associated with the generated individual coffee identifier and the corresponding coffee group spreads curve, thereby providing an indicative offer price to sellers and enabling buyers to submit counter-offer pricing data; a matching module configured to identify one or more matching pairs of buy and sell orders based at least in part on price and quantity criteria derived from the displayed listings and submitted counter-offer pricing data and to automatically transmit electronic trade notifications along with bilateral electronic trading agreements to the corresponding buyers and sellers without requiring manual intervention; an escrow module configured to route a deposit payment from a buyer to an escrow account service provider, where the escrow account service provider holds the deposit payment until confirmation of delivery and quality assessment of the coffee is received, thereby mitigating credit and performance risk associated with the trade; and a storage module configured to store transaction data including the received coffee listing data, the generated coffee group and individual coffee identifiers, the computed coffee group spreads curves, and details of executed transactions.

Example Clause A: A computer-implemented method for providing an online Marketplace and a bilateral spot Trading Platform for green specialty coffee, may include: by a computing device, the device including one or more non-transitory computer-readable media storing computer-executable instructions which when executed by the computing device cause it to perform a method, the method may include: receiving historical price data, the historical price data indicating one or more historical prices for spot transactions in green coffee; receiving current prices of a C-coffee traded financial instrument; receiving from one or more authorized users of the Platform data that establish eligibility to be listed for sale of a holding of the coffee, where the data for each holding may include a weight certification, a certificate of origin, a third party certification of quality grade, and a set of parameters identifying a coffee family group through objective coffee attributes; receiving a plurality of listings of eligible coffee holdings, each listing may include a buy or sell order associated to one of a plurality of authorized users of the Platform (respectively, a buyer or seller), each order pertaining to a spot only transaction in green coffee; determining a coffee group identifier (a universal product identification code for a coffee family group) for each listed coffee holding, based at least in part on the parameters; determining an individual coffee identifier (a universal product identification code for a specific coffee bean) for each listed coffee holding, based at least in part on the parameters and the quality grade; causing to be displayed on a computer terminal connected to the Platform and accessible to the users the Marketplace, which may include the plurality of listings, each being a buy or sell order and each associated to a unique individual coffee identifier; computing for each coffee group identifier, a coffee group identifier spreads curve, representing spot prices for possibly hypothetical coffee holdings belonging to that coffee group of varying quality grades, based at least in part on the parameters and the quality grade; causing to be displayed on a computer terminal connected to the Platform and accessible to the users the coffee group identifier spreads curve, displayed as a spread over a contemporaneous (or nearly contemporaneous) price of the C-coffee traded financial instrument; providing to each seller an indicative price and an opportunity to revise its offer price at the time of listing, the indicative price being based on the corresponding coffee group identifier spreads curve; providing to each buyer an opportunity to propose a counter-offer price at the time of listing to a seller associated to a specific listing; identifying one or more pairs of matching orders from among the plurality of listings representing a buy or sell order, matching as to bid and offer price and unique identifier, and including pairs that may match in part as to quantity; executing the matching pair transactions automatically by means of an automated computing device, without requiring manual intervention by any user of the Platform, and sending to each of the corresponding pairs of seller and buyer an automatic electronic trade notification; upon completion of a transaction, updating the Marketplace display to display for each coffee the quantities and volume-weighted prices transacted, the last executed price per pound for a minimum lot, and to incorporate the extinguishing in whole or in part of orders subject to matching; storing the associated data, including: the received historical price data, with respective dates and times; the current prices of a C-coffee traded financial instrument, with respective dates and times; the transactions executed, each specified as to price, quantity, and individual coffee identifier, with respective dates and times; the periodic Marketplace displays, including bid and offer listings, with respective dates and times; for individual coffees, the daily last bid and offer, the last traded price, the last traded quantity; and the coffee group identifier spreads curves, with respective dates, times, and coffee group identifiers.

Example Clause B: The method of Example Clause A, where each one of the plurality of executed transaction pairs is completed as a transaction through the following steps, including the use of electronic notifications, such as emails: the Platform generates the automatic electronic trade notification, sent to each pair of buyer and seller; the Platform issues to each party of a pair of buyer and seller (the parties) a legally binding spot contract for execution (i.e., signing); upon receipt of a copy of the pair of executed agreements, the Platform automatically sends a notification to a settlement service provider of the details of the transaction, including the names of the parties; the Platform prompts the buyer to transfer the buyer's payment, in an amount specified by the Platform, to a settlement service provider's escrow account; upon the deposit of buyer's payment to the escrow account, the Platform automatically generates a notification to the seller to confirm the escrow deposit, i.e., a notification of trade affirmation, and the seller confirms to the Platform receipt of the notification; the Platform issues a delivery order notification to the seller's warehouse, the warehouse where the coffee subject to sale is stored, with copy notifications to the seller, the buyer, and the settlement service provider, and requests the warehouse to confirm, by an automated Platform reply mechanism, receipt of the delivery order instructions; upon receipt of the warehouse's acknowledgement of the delivery order and its confirmation of fulfillment of the order, the notifications being copied to the seller, the buyer, and the settlement service provider, the Platform issues a request to the buyer to release the deposited escrow account funds and the buyer confirms its authorization for release.

Example Clause C: The method of Example Clause A or Example Clause B, where the legally binding spot contract is a commonly accepted commercial contract (e.g., the Green Coffee Association Contract Terms and Conditions or the European Coffee Federation European Standard Contract).

Example Clause D: The method of any one of Example Clauses A-C, where the legally binding spot contract for execution is processed by a commonly accepted commercial method (e.g., DocuSign).

Example Clause E: The method of any one of Example Clauses A-D, where the payment to seller, the seller payment, is made net of a trading fee retained by the Platform, such as a percentage of the amount paid by the buyer.

Example Clause F: The method of any one of Example Clauses A-E, where the receiving the plurality of listings is supplemented by receiving instructions to cancel listings, each such instruction submitted by the user who posted the corresponding listing, and the updating the Marketplace display is supplemented by incorporating the extinguishing in whole or in part of orders subject to cancellation.

Example Clause G: The method of any one of Example Clauses A-F, where pre-agreement bids and offers are listed anonymously, the identifying one or more pairs of matching orders and the executing the matching pair transactions automatically may take the form of a dynamic double auction, and trade cancellations are restricted to a short window period after notification to the two parties through the automatic electronic trade notification.

Example Clause H: The method of any one of Example Clauses A-G, where the third party certification of quality grade is an internationally recognized certification, such as an SCA (Specialty Coffee Association) grade.

Example Clause I: The method of any one of Example Clauses A-H, where if the seller does not have a third party certification of quality grade, Platform will refer the seller to a list of recognized third party coffee assessment/grading services, to at least one of which the seller will send for analysis a sample of each coffee to be listed.

Example Clause J: The method of any one of Example Clauses A-I, where the set of parameters may include the coffee country of origin; the plant species; whether or not the coffee is organic; the size of the bean; the process, i.e., the manner in which the coffee is treated once it is harvested; the harvest year; and whether the coffee is of single origin or is a blend.

Example Clause K: The method of any one of Example Clauses A-J, where the country of origin is one of approximately 70 recognized coffee producing countries in the world, the plant species is typically one of 7 known plants (including Arabica, Robusta, Liberica, Hybrid, Excelsa, and Other), the variety is usually one of 57 different possible types, the size of the bean is expressed in 1/64th's of an inch, the process is typically one of 9 recognized processes for the treatment of specialty coffee beans post-harvest, the harvest year can span adjacent years (e.g., 2023/2024), and blend refers to a blend of coffees across different producers, whereas single origin refers to a single farm (or producer), including microlot coffees (coffees available only in small quantities).

Example Clause L: The method of any one of Example Clauses A-K, where the computing, for each coffee group identifier, a coffee group identifier spreads curve utilizes a mathematical algorithm employing cubic spline and regression curve fitting techniques.

Example Clause M: The method of any one of Example Clauses A-L, where the C-coffee traded financial instrument is a nearest C-coffee futures contract traded on I.C.E. (the InterContinental Exchange), and the coffee group identifier spreads curve is expressed as a spread over the C-coffee price in cents per pound.

Example Clause N: The method of any one of Example Clauses A-M, where the received historical price data include price data for coffee futures transactions.

Example Clause O: The method of any one of Example Clauses A-N, where the authorized user is one of a corporation, a limited liability company, a partnership, or a sole proprietor; the Marketplace and Trading Platform is made available to users on a 24-hour a day basis; the window period is 5 minutes; the minimum lot is 600 kg., representing 10 bags each of 60 kg.

Example Clause P: The method of any one of Example Clauses A-O, where use of the Platform to execute transactions does not guarantee performance of the bilateral contract between the buyer and the seller; does not guarantee the quality of the green coffee subject to the contract between the buyer and the seller; does not provide but only facilitates engagement of a settlement service, and settlement takes place off Platform; does not directly or indirectly obligate the Platform to be a party to or a participant in any trade or transaction entered or otherwise conducted through or on the Platform.

Example Clause Q: The method of any one of Example Clauses A-P, where, for the listed coffees taken as a whole, the coffee group identifiers, the individual coffee identifiers, and the coffee group identifier spreads curves provide a universal taxonomy for specialty coffee.

Example Clause R: The method of any one of Example Clauses A-Q, where the Platform generates advertising displays, and provides access to analytical reports on market statistics and market analyses, possibly in exchange for a subscription or other fee.

Example Clause S: A computer-implemented method for computing a specialty coffee market pressure indicator, may include: by a computing device, the device including one or more non-transitory computer-readable media storing computer-executable instructions which when executed by the computing device cause it to perform a method, the method may include: receiving historical price data, the historical price data indicating one or more historical prices for spot transactions in green coffee; receiving one or more sets of current prices of spot quotes in green coffee, the quotes indicating bid or offer prices and associated quantities, and the prices being contemporaneous or nearly contemporaneous prices with each other; receiving current spot transaction prices in green coffee, with associated quantities, the transaction prices pertaining to execution times close to those of one set of the current prices of spot quotes (such as same day prices); receiving a value of an intermediation fee, expressed as a percentage of price; computing a market pressure indicator, based at least in part on the historical price data, the intermediation fee, the current quote prices, and the current transaction prices, where the frequency-of-occurrence distribution of the historical prices are transformed to a current distribution of prices through an Esscher transform (an exponentially tilted modification) depending on a value of the market pressure indicator as fixed coefficient of price in the exponent, and the value is selected to optimize fit to the quantity-weighted quote distribution, or an average of a set of quote distributions, with regard to its mean, variance, skewness, and kurtosis (and possibly higher moments); displaying the value of the market pressure indicator as a scalar number, either zero or a positive or negative number, on an online platform accessible to users of the platform by electronic means; storing the market pressure indicator.

Example Clause T: A computer-implemented method for providing an online Marketplace and bilateral spot Trading Platform for raw oysters, may include: by a computing device, the device including one or more non-transitory computer-readable media storing computer-executable instructions which when executed by the computing device cause it to perform a method, the method may include: receiving historical price data, the historical price data indicating one or more historical prices for spot transactions in raw oysters, expressed in U.S. dollars per dozen; receiving from one or more authorized users of the Platform data that establish eligibility to be listed for sale of a holding of the oysters, where the data may include the number of oysters held, date of harvesting, an assurance of quality (e.g., hand selected and graded in the field and at the wet storage facility), whether or not the oysters are harvested in a sustainable way from traceable and verified clean open areas, the following four parameters: grow-out region (East coast, West coast, Gulf coast, Unspecified), species (e.g., Eastern, Pacific), size, and whether farmed or wild-caught, and specification of special attributes, which must include location of origin (e.g., a named bay, a named sound, a farm name, a farm owner), brand name, if any, and may include other attributes, such as taste profile using a specified scale, salinity, and grow-out method (e.g., bottom culture, off-bottom rack culture, off-bottom cage culture, off-bottom bag culture); receiving a plurality of listings of eligible oyster holdings, each listing may include a buy or sell order associated to one of a plurality of authorized users of the Platform (respectively, a buyer or seller), each order pertaining to a spot only transaction in raw oysters, and each sell or buy order subject to a respective minimum lot size at initial listing; and, separately, associated shipping costs charged by the seller to the buyer for delivery on a specified date to a specified address in a specified delivery region (one of four regions, South, Northeast, Pacific, Midwest) by a specified method of transportation (e.g., overnight delivery packed in an insulated box with cold packs); determining an oyster group identifier (a universal product identification code for an oyster family) for each listed oyster holding, based at least in part on the parameters; determining an individual oyster identifier (a universal product identification code for a specific oyster holding) for each listed oyster holding, based at least in part on the parameters and the special attributes; causing to be displayed on a computer terminal connected to the Platform and accessible to the users a Marketplace, which may include the plurality of listings, each being a buy or sell order and each associated to a unique individual oyster identifier; computing for each oyster group identifier, an oyster group identifier surface, representing spot prices for possibly hypothetical oyster holdings belonging to that oyster group of varying special attributes, based at least in part on the parameters, the special attributes, the delivery region (South, Northeast, Pacific, Midwest) and the associated shipping costs; causing to be displayed on a computer terminal connected to the Platform and accessible to the users the oyster group identifier curves, being cross-sections of the identifier surface varying with one special attribute at convenient fixed values of the other special attributes, displayed as a price per dozen oysters; providing to each seller an indicative price or price range and an opportunity to revise its offer price at the time of listing, the indicative price or price range being based on the corresponding oyster group identifier curves; providing to each buyer an opportunity to propose a counter-offer price at the time of listing to a seller associated to a specific listing; identifying one or more pairs of matching orders from among the plurality of listings representing a buy or sell order, matching as to bid and offer price and unique identifier, and including pairs that may match in part as to quantity; executing the matching pair transactions automatically by means of an automated computing device, without requiring manual intervention by any user of the Platform, and sending to each of the corresponding pairs of seller and buyer an automatic electronic trade notification; upon completion of a transaction, where in certain embodiments the buyer deposits payment in an escrow account, updating the Marketplace display to display for each oyster listing the quantities and volume-weighted prices transacted, the last executed price per dozen for a minimum lot, and to incorporate the extinguishing in whole or in part of orders subject to matching; storing the associated data, including: the received historical price data, with respective dates and times; the transactions executed, each specified as to price, quantity, and individual oyster identifier, with respective dates and times; the periodic Marketplace displays, including bid and offer listings for individual oyster holdings, with respective dates and times, the daily last bid and offer, the last traded price, the last traded quantity; and the oyster group identifier surface and curves, with respective dates, times, and oyster group identifiers.

Example Clause U: A computer-implemented method for providing an online Marketplace and bilateral spot Trading Platform for a soft commodity, where the soft commodity is boxed beef, or live cattle, or feeder cattle, or cotton, or cocoa, or sugar, or clams, or Bluefin tuna, or a soft commodity denominated in euro rather than US dollars, such as wheat, or barley, or maize, or any other soft commodity, may include: by a computing device, the device including one or more non-transitory computer-readable media storing computer-executable instructions which when executed by the computing device cause it to perform a method, the method may include: receiving historical price data, the historical price data indicating one or more historical prices for spot transactions in the soft commodity; receiving current prices for the soft commodity of a nearest futures contract traded on a commonly recognized futures trading exchange, if there exists such a contract; receiving from one or more authorized users of the Platform data that establish eligibility to be listed for sale of a holding of the soft commodity, where for each holding the data may include a warehouse name and its location, weight or quantity certification, a certificate of origin, a third party certification of quality grade if such a grade is commonly required in commercial transactions in the soft commodity, and a set of parameters identifying a soft commodity family group through objective attributes of the soft commodity; receiving a plurality of listings of eligible soft commodity holdings, each listing may include a buy or sell order associated to one of a plurality of authorized users of the Platform (respectively, a buyer or seller), each order pertaining to a spot only transaction in the soft commodity; determining a soft commodity group identifier (a universal product identification code for a soft commodity family group) for each listed soft commodity holding, based at least in part on the parameters; if a quality grade is received, determining an individual soft commodity identifier (a universal product identification code for a specific holding of the soft commodity) for each listed soft commodity holding, based at least in part on the parameters and the quality grade; causing to be displayed on a computer terminal connected to the Platform and accessible to the users a Marketplace, which may include the plurality of listings, each being a buy or sell order and each associated to a soft commodity group identifier, and, if a quality grade is received, a unique individual soft commodity identifier; if a quality grade is received, computing for each soft commodity group identifier, a soft commodity group identifier spreads curve, representing spot prices for possibly hypothetical soft commodity holdings belonging to that soft commodity group of varying quality grades, based at least in part on the parameters and the quality grade; if a quality grade is received and if a futures contract price is received, causing to be displayed on a computer terminal connected to the Platform and accessible to the users the soft commodity group identifier spreads curve, displayed as a spread over a contemporaneous (or nearly contemporaneous) price of the nearest futures contract; if only a quality grade is received but not a futures contract price, causing to be displayed on a computer terminal connected to the Platform and accessible to the users the soft commodity group identifier spreads curve, displayed as an absolute level of prices; identifying one or more pairs of matching orders from among the plurality of listings representing a buy or sell order, matching as to bid and offer price and identifier, and including pairs that may match in part as to quantity; executing the matching pair transactions automatically by means of an automated computing device, without requiring manual intervention by any user of the Platform, and sending to each of the corresponding pairs of seller and buyer an automatic electronic trade notification; upon completion of a transaction, where in certain embodiments the buyer deposits payment in an escrow account, updating the Marketplace display to display for each soft commodity the quantities and volume-weighted prices transacted, the last executed price for a minimum lot, and to incorporate the extinguishing in whole or in part of orders subject to matching; storing the associated data, including: the received historical price data, with respective dates and times; the current prices of a nearest futures contract, if applicable, with respective dates and times; the transactions executed, each specified as to price, quantity and applicable identifier, with respective dates and times; the periodic Marketplace displays, including bid and offer listings, with respective dates and times; for individual soft commodities, if applicable, otherwise for the soft commodity group, the daily last bid and offer, the last traded price, the last traded quantity; and, if applicable, the soft commodity group identifier spreads curves, with respective dates, times, and soft commodity group identifiers.

In view of the many possible embodiments to which the principles of the disclosed technology may be applied, it should be recognized that the illustrated embodiments are only preferred examples and should not be taken as limiting the scope of the disclosure. Rather, the scope of the disclosure is at least as broad as the following claims and equivalents of the recited features. I therefore claim all that comes within the scope and spirit of these claims.

1. A method for providing an online marketplace and bilateral spot trading platform for green specialty coffee, comprising:
receiving, from one or more authorized users, coffee listing data that includes a plurality of coffee parameters and at least one quality grade obtained from a third-party quality certification;
determining, by a computing device, a coffee group identifier for each coffee listing based at least in part on the received coffee parameters;
generating an individual coffee identifier for each coffee listing based at least in part on the determined coffee group identifier and the received quality grade information;
computing a coffee group spreads curve for each coffee group identifier based on historical trading data and current market information, wherein the spreads curve represents indicative spot prices as a spread over a contemporaneous C-coffee traded financial instrument;
displaying on an online marketplace interface the plurality of coffee listings, each associated with an individual coffee identifier and the corresponding coffee group spreads curve, thereby providing an indicative offer price to sellers and an opportunity for buyers to submit counter-offer pricing data;
identifying one or more matching pairs of buy and sell orders based at least in part on price and quantity criteria derived from the displayed listings and submitted offers;
automatically executing the matching transactions by generating and transmitting electronic trade notifications and a bilateral electronic trading agreement to the corresponding buyer and seller without requiring manual intervention;
updating the online marketplace display to reflect executed transactions by displaying transacted quantities and volume-weighted prices; and
storing transaction data, including the received listing data, the generated coffee group and individual coffee identifiers, the computed spreads curves, and details of the executed transactions.

2. The method of claim 1, wherein the plurality of coffee parameters includes origin, processing type, bean size, and production year.

3. The method of claim 1, wherein the at least one quality grade is an internationally recognized quality certification.

4. The method of claim 1, further comprising receiving a coffee quality report generated by an accredited third-party quality assessment service provider, wherein activation of a coffee listing is contingent upon receipt of the coffee quality report.

5. The method of claim 1, wherein computing the coffee group spreads curve comprises employing cubic spline functions and regression curve fitting techniques based on the historical trading data and the current price of a contemporaneous C-coffee traded financial instrument.

6. The method of claim 1, wherein displaying the online marketplace interface comprises presenting the coffee listings on a graphical user interface that enables buyers to submit counter-offer pricing data, and enables buyers and sellers to view real-time volume-weighted prices and last executed prices for a predetermined minimum lot.

7. The method of claim 1, further comprising automatically executing the matching transactions through a dynamic double auction process, wherein pre-agreement bids and offers are listed anonymously.

8. The method of claim 7, wherein trade cancellations are permitted within a predetermined period following trade notification, subject to mutual agreement of the buyer and seller.

9. The method of claim 1, further comprising generating and transmitting electronic trade notifications that include a legally binding spot trading agreement executed via an electronic signature process.

10. The method of claim 1, wherein updating the online marketplace display further comprises reflecting transacted quantities, volume-weighted prices, and the last executed price per pound for a minimum lot of coffee.

11. The method of claim 1, wherein storing the transaction data comprises recording timestamps for each receipt of coffee listing data, execution of transactions, and marketplace display update to facilitate audit and traceability.

12. The method of claim 9, further comprising, upon receipt of the executed agreements, routing a deposit payment from the buyer to an escrow account service provider, wherein the escrow account service provider is a third-party financial institution that holds the buyer's deposit payment until confirmation of delivery and quality assessment of the coffee, at which point the funds are released to the seller, thereby mitigating credit and performance risk associated with the trade.

13. A computer-implemented method for facilitating secure bilateral spot trading of green specialty coffee, the method comprising:
receiving, via a computing device, coffee listing data from one or more authorized users, the coffee listing data including a set of coffee parameters comprising origin, processing type, bean size, and production year, and a quality grade certification provided by an accredited third-party quality assessment service provider;
generating, by the computing device, a distinct coffee group identifier for each coffee listing based at least in part on the received set of coffee parameters;
generating, by the computing device, an individual coffee identifier for each coffee listing based at least in part on the generated coffee group identifier and the quality grade certification;
computing, by the computing device, a pricing curve for each coffee group identifier based on a combination of historical trading data, including spot prices for green specialty coffee and a current market price derived from a contemporaneous C-coffee traded financial instrument, wherein the pricing curve represents indicative spot price spreads for varying quality grades within the coffee group;
displaying, on an online marketplace interface accessible to the authorized users, the plurality of coffee listings, each associated with the distinct individual coffee identifier and the corresponding pricing curve, thereby providing an indicative offer price to sellers and enabling buyers to submit counter-offer pricing data;
receiving, via the computing device, bid or counter-offer pricing data from a buyer for a selected coffee listing;
identifying, by the computing device, at least one matching pair of buy and sell orders based at least in part on bid and offer prices and quantity criteria derived from the displayed listings and submitted pricing data;
automatically executing, by the computing device, the matching pair of buy and sell orders to form a bilateral electronic trading agreement and generating electronic trade notifications for the corresponding buyer and seller without requiring manual intervention; and
routing a deposit payment from the buyer to an escrow account service provider, wherein the escrow account service provider holds the payment until confirmation of delivery and quality assessment of the coffee is received, at which point the funds are released to the seller.

14. The computer-implemented method of claim 13, wherein displaying the online marketplace interface further comprises presenting real-time volume-weighted prices and the last executed price per pound for a predetermined minimum lot of coffee.

15. The computer-implemented method of claim 13, further comprising identifying the matching pair of buy and sell orders by implementing a dynamic double auction process wherein pre-agreement bids and offers are maintained on a blind basis.

16. The computer-implemented method of claim 13, wherein receiving the bid or counter-offer pricing data comprises accepting such pricing data via a graphical user interface that presents the coffee listings and corresponding pricing curves in real time.

17. The computer-implemented method of claim 13, wherein automatically executing the matching pair of buy and sell orders further comprises generating and transmitting electronic trade notifications that include a legally binding spot trading agreement executed via an electronic signature process.

18. The computer-implemented method of claim 13, wherein routing the deposit payment further comprises transmitting an electronic confirmation notification to the corresponding buyer and seller upon receipt of the deposit payment by the escrow account service provider.

19. The computer-implemented method of claim 13, wherein the escrow account service provider is a third-party financial institution that holds the buyer's deposit payment until confirmation of both physical delivery and an independent quality assessment of the coffee is received, and wherein the funds are released to the seller thereafter.

20. A system for facilitating secure bilateral spot trading of green specialty coffee via an online marketplace, comprising:
a network interface module configured to receive, from one or more authorized users, coffee listing data that includes a set of coffee parameters and an associated quality certification from a third-party quality assessment service provider;
a coffee identifier module configured to determine a coffee group identifier for each coffee listing based at least in part on the received coffee parameters and to generate an individual coffee identifier for each listing based at least in part on the determined coffee group identifier and the associated quality certification;
a pricing module configured to compute a coffee group spreads curve for each coffee group identifier based at least in part on historical trading data and current market information derived from a contemporaneous C-coffee traded financial instrument, wherein the computed spreads curve represents indicative spot prices as a spread over the C-coffee price;
a display module operatively coupled to the network interface module and configured to present on an online marketplace interface the plurality of coffee listings, each associated with the generated individual coffee identifier and the corresponding coffee group spreads curve, thereby providing an indicative offer price to sellers and enabling buyers to submit counter-offer pricing data;
a matching module configured to identify one or more matching pairs of buy and sell orders based at least in part on price and quantity criteria derived from the displayed listings and submitted counter-offer pricing data and to automatically transmit electronic trade notifications along with bilateral electronic trading agreements to the corresponding buyers and sellers without requiring manual intervention;
an escrow module configured to route a deposit payment from a buyer to an escrow account service provider, wherein the escrow account service provider holds the deposit payment until confirmation of delivery and quality assessment of the coffee is received, thereby mitigating credit and performance risk associated with the trade; and
a storage module configured to store transaction data including the received coffee listing data, the generated coffee group and individual coffee identifiers, the computed coffee group spreads curves, and details of executed transactions.
